(19) United States
(12) Patent Application Publication
(10) Pub. No.: US 2021/0406839 A1
(43) Pub. Date: Dec. 30, 2021

(54) COMPUTERIZED MEETING SYSTEM

(71) Applicant: Capital One Services, LLC, McLean, VA (US)

(72) Inventors: Christopher CAMENARES, Falls Church, VA (US); Jason TROST, Atlanta, GA (US); Patrick SOFO, Arlington, VA (US); Joseph BOAYUE, Reston, VA (US); Vincent PHAM, Champaign, IL (US); Ana CRUZ, Arlington, VA (US); Nahid Farhady GHALATY, Fairfax, VA (US); Geeta SHYAMALA, Herndon, VA (US)

(73) Assignee: Capital One Services, LLC, McLean, VA (US)

(21) Appl. No.: 16/914,754

(22) Filed: Jun. 29, 2020

(51) Int. Cl. G06Q 10/10; G06Q 10/04; G10L 17/00; G10L 17/02; G06F 16/16; G06N 20/00

(52) U.S. Cl. CPC G06Q 10/1095; G06Q 10/1091; G06Q 10/04; G06N 20/00; G10L 17/02; G06F 16/164; G10L 17/005

(57) ABSTRACT

Systems, methods, and computer-readable storage media for quantifying meeting effectiveness for a group of participants and reducing redundancies in future meetings. The system receives electronic transcripts for meetings and executes natural language processing on the respective transcripts. The system identifies keywords in the resulting, parsed transcripts, tags the transcript with metadata about the keywords, and generates meeting profiles for the respective meetings. The system then compares the generated meeting profiles, identifies points of redundancy between the meetings from that comparison, and modifies a future meeting based on the identified redundancies.

### BACKGROUND

### 1. Technical Field

The present disclosure relates to a computerized meeting system, and more specifically to reducing meeting redundancy by quantifying past meetings, identifying points of redundancy, and modifying future meetings based on the points of redundancy.

### 2. Introduction

Metrics regarding meeting participation and efficiency do not take into account the actual speaking time of the participants, words used by participants, and other quantitative aspects of the meeting. Because of this lack of quantification, meeting participation and efficiency is often incorrectly estimated using guesswork rather than being based on quantifiable, collected data.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media a technical solution to the technical problem described. A method for performing the concepts disclosed herein can include receiving, at a server, a first electronic transcript for a first meeting, the first electronic transcript identifying by time stamps both participants and speakers within the first meeting; executing, via a processor of the server, natural language processing on the first electronic transcript, resulting in a first parsed electronic transcript, the first parsed electronic transcript comprising (1) text of the first meeting, (2) speaker timestamps indicating when a speaker begins or ends speaking within the first meeting, and (3) participant timestamps indicating when participants join or exit the first meeting; identifying, via the processor, keywords within the first parsed electronic transcript; tagging, via the processor, the first parsed electronic transcript with first metadata, resulting in a tagged first parsed electronic transcript, the first metadata comprising, for each keyword in the keywords, a number of instances the each keyword was communicated in the first electronic transcript; generating, via the processor, a first statistical profile of the first meeting based on the participants, the speakers, and a first ratio of the keywords tagged in the first metadata; receiving, at the server, a second electronic transcript for a second meeting, the second electronic transcript identifying by time stamps both participants and speakers within the second meeting; executing, via the processor, natural language processing on the second electronic transcript, resulting in a second parsed electronic transcript, the second parsed electronic transcript comprising (1) text of the second meeting, (2) speaker timestamps indicating when a speaker begins or ends speaking within the second meeting, and (3) participant timestamps indicating when participants join or exit the second meeting; identifying, via the processor, the keywords within the second parsed electronic transcript; tagging, via the processor, the second parsed electronic transcript with second metadata, resulting in a tagged second parsed electronic transcript, the second metadata comprising, for each keyword in the keywords, a number of instances the each keyword was communicated in the second electronic transcript; generating, via the processor, a second statistical profile of the second meeting based on the participants, the speakers, and a second ratio of the keywords tagged in the second metadata; comparing, via the processor, the first statistical profile to the second statistical profile, resulting in a statistical comparison; and modifying, via the processor, a previously scheduled third meeting based on the statistical comparison, the modifying of the previously scheduled third meeting comprising transmitting electronic meeting updates to a plurality of devices associated with personnel invited to the previously scheduled third meeting.

A system configured to perform the concepts disclosed herein for automatically reducing meeting redundancy can include a database storing a plurality of communication profiles, each communication profile associated with a respective user, each communication profile in the plurality of communication profiles comprising a data structure storing data comprising (1) a syntactic pattern followed by the respective user, (2) a statistical profile of user engagement of the respective user, and (3) a list of topics ranked according to interaction of the respective user; a processor; and a non-transitory computer-readable storage medium having instructions stored which, when executed by the processor, cause the processor to perform operations comprising: receiving an electronic transcript for a meeting, the meeting having a plurality of participants; retrieving, from the database, a communication profile for each participant in the plurality of participants, resulting in a plurality of meeting communication profiles; aggregating the plurality of meeting communication profiles into an aggregated participant profile for the meeting, the aggregated participant profile comprising (1) a weighted syntactic pattern of the plurality of participants, (2) a weighted statistical profile, and (3) an aggregated ranked list of topics; performing natural language processing on the electronic transcript, resulting in a parsed electronic transcript; generating a meeting effectiveness score for the meeting by comparing the parsed electronic transcript to the aggregated participant profile; and modifying a scheduled meeting based on the meeting effectiveness score, the modifying of the scheduled third meeting comprising transmitting at least one electronic meeting update to devices associated with personnel invited to the scheduled third meeting.

A non-transitory computer-readable storage medium configured as disclosed herein can have instructions stored which, when executed by a computing device, cause the computing device to perform operations which include retrieving, from a database, a first electronic transcript for a first meeting and a second electronic transcript for a second meeting; performing natural language processing on the first electronic transcript and the second electronic transcript, resulting in a first parsed electronic transcript and a second parsed electronic transcript; identifying, using the first parsed electronic transcript, first topics discussed in the first meeting; retrieving, from the database, first individual communication profiles of participants in the first meeting; aggregating the first individual communication profiles, resulting in a first aggregated profile; scoring an effectiveness of the first meeting using the first aggregated profile, resulting in a first meeting effectiveness score; identifying, using the second parsed electronic transcript, second topics discussed in the second meeting; retrieving, from the database, second individual communication profiles of participants in the second meeting; aggregating the second individual communication profiles, resulting in a second aggregated profile; scoring an effectiveness of the second meeting using the second aggregated profile, resulting in a second meeting effectiveness score; identifying common keywords within the first parsed electronic transcript and the second parsed electronic transcript; identifying a scheduled meeting, the scheduled meeting having previously assigned participants and topics; determining a redundancy exists between the scheduled meeting and at least one of the first meeting and the second meeting using the common keywords, the first meeting effectiveness score, and the second meeting effectiveness score; and modifying, by transmitting electronic meeting updates to a plurality of devices associated with personnel invited to the scheduled meeting, at least one of the participants and the topics of the scheduled meeting to remove the redundancy.

### BRIEF DESCRIPTION OF THE DRAWINGS

FIG. 1 illustrates an example of identifying redundancy between two meetings;

FIG. 2 illustrates an example of comparing meeting profiles to identify if redundancies exist;

FIG. 3 illustrates an example of generating meeting effectiveness scores for meetings based on individual profiles;

FIG. 4 illustrates an example of issuing revised electronic invitations based on a meeting effectiveness score;

FIG. 5 illustrates an example method embodiment; and

FIG. 6 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

A system, method and computer-readable media are disclosed which reduce redundancy in meetings by quantifying meetings using natural language processing and statistical analysis, identifying redundancies between the meetings, and modifying future meetings to remove identified redundancies from future meetings. In addition, the identification of redundancies and modification of future meetings can be based on how effective the meetings are for individuals participating in the meetings and/or how effective the meetings are for a group of individuals.

Consider the following example. A system (such as a server) configured according to this disclosure can receive audio recordings of each respective meeting, convert (using speech-to-text processing) the audio recordings into electronic transcripts, perform natural language processing on the electronic transcripts, which results in parsed electronic transcripts. The system can generate meeting statistics based on the parsed electronic transcripts of the respective meetings, and using those meeting statistics generate meeting profiles for the respective meetings, compare the meeting profiles, and identify redundancies found in the respective meeting profiles. The system can then modify scheduled meetings to reduce the redundancies. For example, the system can send out updated electronic invitations to meeting invitees, where the updated electronic invitations cancel invitations to redundant personnel identified by the system. Similarly, the updated electronic invitations can change topics, subjects, speakers, or other aspects of a scheduled meeting based upon the evaluations.

In some configurations, the identification of redundancy can be based on how effective the meeting was for the individual participants. For example, individuals can have their own personal communication profiles generated by the system which identify how the respective users prefer to communicate and be communicated with. These profiles can be generated with user input, based on previous interactions, and/or identify specific preferences regarding topic, communication partners, time of day, etc. The system can aggregate multiple individual user profiles together, resulting in an aggregated user profile for the participants of a given meeting, then judge the efficacy of the meeting based on how the statistical analysis results compare to the aggregated profile. The efficacy determination can result in a meeting score which, in conjunction with the identification of points of redundancy, can lead to changes in future meetings.

Audio recordings can be stored in a database which may or may not be part of the system processing audio signals. The recordings can be from “live,” in-person meetings where an audio recording was kept during the meeting. In addition, the recordings can be from conference calls, telephone or Voice-Over-IP (VOIP) calls, etc. The audio recordings can, in some configurations, be extracted from video of a meeting. For example, if there is a video recording of a meeting, the audio portion of the video can be extracted and processed as an audio track.

While the disclosed systems are configured to receive audio recordings, then convert those audio records to electronic transcripts via a processor executing speech-to-text algorithms, preferably the system only stores tagged segments of parsed electronic transcripts. That is, while the database can store the audio recordings, preferably the database stores parsed segments which have been tagged with metadata based on aspects such as topic, context, speaker, time, duration. In some cases, the tags generated for a specific user can be selected based on that user's past behavior. For example, if the user is normally silent in meetings, then one day is particularly conversational, the system can generate tags identifying the topic, context, etc., as inducing the user's participation. Stored, tagged, electronic transcript segments can then be retrieved by the system when doing further analysis of meeting effectiveness and efficacy.

When an individual is setting up a new meeting using a software program such as MICROSOFT OUTLOOK (in combination with the disclosed invention), the system can provide to the organizer suggestions regarding participants, time of day, topic, conflicts of interest, redundancy alerts (if, for example, another similar meeting has just occurred, or is already scheduled), etc. The system can provide to the organizer suggestions which can be used to formulate the meeting, or can (in some configurations) autofill the meeting based on the redundancy findings and previous inputs given by the meeting organizer.

In addition, a user is able to better search through existing meetings using rankings of the meetings, where the rankings are according to usefulness, attendance, topic, duration, and/or other quantifiable aspects of the meetings. Finally, users with appropriate credentials (such as managers or organizers) can evaluate the usefulness of a meeting by seeing meeting analytics, such as predicted redundancies before the meeting occurs, the redundancies identified after the meeting, duration, topics planned versus topics actually discussed.

As the user participates in future meetings, data about a specific meeting can be extracted from media such as audio or video, then compared to the user meeting profile to quantifiably determine if the meeting was effective for the user. Extracting data from the media can, for example, entail using speech to text processing to convert the audio/video recording to an electronic transcript. Additional meeting data, in the form of already executed transcripts, meeting notes, emails, etc., can, in some circumstances, also be used as inputs (electronic transcripts) to the system. The system can then use processor based natural language processing on the resulting electronic transcript to identify syntax, prosody (relying on timestamps within the electronic transcripts), vocabulary, and other aspects of how the user communicates. The system can also execute a statistical analysis on aspects of the user's speech identified by the natural language processing, then use the data from the natural language processing and the statistical analysis to generate a meeting profile for the individual user, with the meeting profile identifying how the user prefers to interact in meetings. The meeting profile can also include goals, criteria, or other factors entered by the user themselves. For example, the user can indicate what they value in meetings, what their goals are, if there are specific individuals (or characteristics of individuals) that they do not enjoy, etc.

When the user participates in a new meeting, the system can then compare the user's meeting profile to an electronic transcript of the meeting, where the electronic transcript is subjected natural language processing and/or statistical analysis, to generate a meeting effectiveness score which is tailored to the user based on the user's profile and based on what was said during the meeting, who spoke during the meeting, who was present/participated in the meeting, etc.

In some cases, the meeting effectiveness score can then be used to modify scheduled future meetings by sending out electronic modifications to already distributed electronic meeting invitations. For example, if after a meeting the meeting effectiveness scores were poor for the majority of the individuals in the meeting, the system can change the topic, agenda, order of speakers, time of meeting, participants, etc., to change the already distributed electronic meeting data such as the electronic meeting invitations.

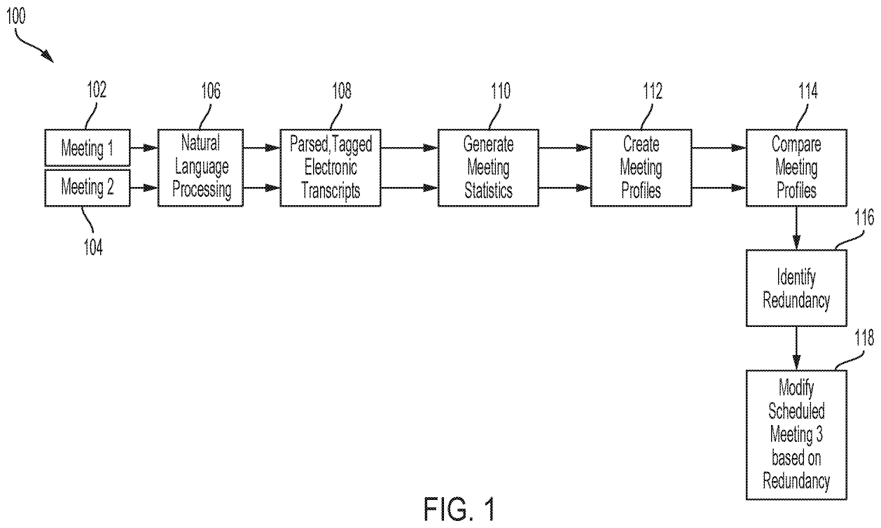

These variations and others shall be described herein as the various illustrations are set forth and discussed. FIG. 1 illustrates an example 100 of identifying redundancy between two meetings. In this example, two meetings 102, 104 occur, and the system performs natural language processing 106 on both. The resulting parsed electronic transcripts are tagged according to topic, sentence structure, participants, time of day, etc., resulting in parsed, tagged electronic transcripts 108. The parsed, tagged, electronic transcripts 108 can be stored in a database, and in some cases these transcripts 108 can be further divided into parsed, tagged segments or portions of the parsed, tagged electronic transcripts 108. Using the resulting parsed, tagged electronic segments, the system generates meeting statistics 110 for each respective meeting 102, 104. These statistics can include information such as which was participant speaking at a given time, topics covered, duration, audience participation, syntax, sentence structure most commonly deployed, use of slang, etc. The statistics can be specific to a given segment, however preferably are aggregated across all of the segments generated from the respective meeting 102, 104. In some cases, where individual users have communication profiles previously defined, the meeting statistics can include a score or other measurement indicating how effective the respective meeting was for that individual.

In an exemplary embodiment, a list of potential tags can be pre-configured for the particular implementation. For example, “fraud” and “banking” may be tags provided in a set of tags for use at a financial institution. Other implementations may include tags relevant to that use case. The list of potential tags may also initially be empty and added to via machine learning. Along those lines, words not in this initial set, but that come up frequently across the enterprise (excluding “the”, “and”, etc.) may also be included as potential tags. This may be done by machine learning, tracking the number of times a word is encountered, etc. Thus, the list of potential tags may be dynamic. The system may attempt to extract all tags detected and determines necessity by those that match the dynamic list.

The tags may be stored in a database, and arranged in their own table. For example, the database may include a relation indicating “fraud in segment 34239”; and a second “banking in segment 34239”; and so on, for all segments stored.

The meeting statistics and the results of the natural language processing together can be used to create a meeting profile 112 for each meeting 102, 104, the meeting profile containing information about meeting. The meeting profile can be thought of as a meeting summary generated using the quantitative data gleaned through the natural language processing and the statistical analysis. Exemplary data which can be contained in the meeting profile can include the meeting statistics as well as information about the meeting, such as who participated, when the meeting occurred, the meeting's overall duration, time of day of the meeting, etc.

The system can then compare the meeting profiles 114 generated to one another, and identify points of redundancy 116 between the respective meetings 102, 104. As illustrated, the system is comparing the two meetings 102, 104 which have already finished and been analyzed, with the appearance that the meetings 102, 104 are occurring simultaneously or at least in a similar time frame. However, in practice the meetings 102, 104 can occur simultaneously or at significantly distinct times. For example, one meeting 102 could have occurred over a year before the second meeting 104, with the respective meeting profiles being compared 114 only after the second meeting data has been processed and analyzed. During the intermediate time (between the meetings 102, 104), the system can store the meeting data in a database for future use in identifying redundancies.

The system can then modify a scheduled third meeting 118 based on one or more redundancies identified. In alternative configurations, the system can auto-fill, or make suggestions for, a new meeting using the identified redundancies. Modification of a scheduled meeting can involve updating a meeting invitation distributed across a network and stored in multiple distinct computer systems using an electronic update to the meeting. The electronic update can, for example, only modify those aspects of the scheduled meeting which are being changed.

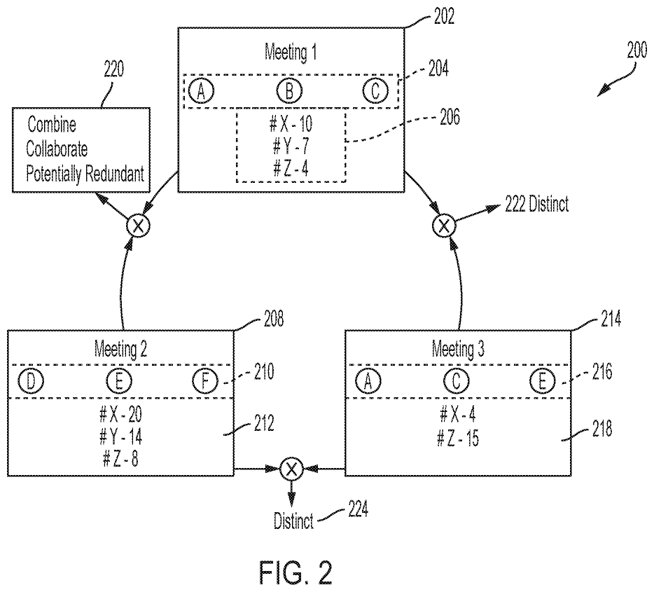

FIG. 2 illustrates an example 200 of comparing meeting profiles to identify if redundancies exist. In this example, there are meeting profiles 202, 208, 204 corresponding to three separate meetings. In the profile of meeting 1 202 are stored participants 204, as well as tags 206 corresponding to topics discussed in the meeting. In this example 200, the participants 204 for meeting 1 202 are A, B, and C, and the tagged topics discussed 206 in meeting 1 are X, Y, and Z. For meeting 2 208, participants 210 are D, E, and F, and topics 212 are also X, Y, and Z. For meeting 3 214, participants 216 are A, C, and E, and topics 218 discussed are X and Z.

The system compares 220, 222, 224 each meeting profile 202, 208, 214 to the other meeting profiles. In a first comparison 220 between meetings 1 202 and 2 208, the system can identify that the participants 204, 210 between the meetings are distinct. However, the system can also the topics 206, 212 discussed in each of the meetings 202, 208 as identical. More specifically, the system can consider the ratio at which the topics 206 are discussed with respect to one another in the first meeting (X—discussed 10 times, Y—discussed 7 times, and Z discussed 4 times), and determine that the ratio of discussion of those same topics in meeting 2 208 (X—discussed 20 times, Y—discussed 14 times, Z discussed 8 times) is identical to that of meeting 1 202. That is, the 10-7-4 ratio of topic discussion in meeting 1 202 is identical to the 20-14-8 ratio of topic discussion in meeting 2 208. Based on different participants 204, 210, the same topics 204, 210 being discussed, and those topics 204, 210 having the exact same ratio of relative discussion, the system can determine that the meetings 202, 208 should be combined in the future, that collaborations between the two groups are needed, and/or that elements of the meetings 202, 208 are redundant.

By contrast, the comparisons 222, 224 of meetings 1 202 to 3 214 and meetings 2 208 to 3 214 reveal the respective meetings to be distinct. In the case of comparing 222 meeting 1 202 to meeting 3 214, only one the participants 204, 216 are distinct (E), and the topics discussed 206, 218 are distinct. Moreover, the ratio of discussion of topics X and Z in meeting 3 214 (X—14, Z—15) is very distinct than the ratio of those same topics in meeting 1 202 (X—10, Z —4). Based on these distinctions, the system does not identify any redundancies in between meetings 1 202 and 3 214. If all three participants in each meeting had been identical, the system may have identified the meetings as redundant, despite the topical discussion ratios being distinct. In the case of comparing 224 meeting 2 208 to meeting 3 214, the meetings are similarly identified as distinct due to distinct topical discussion ratios, despite a single user (E) participating in both meetings 208, 214.

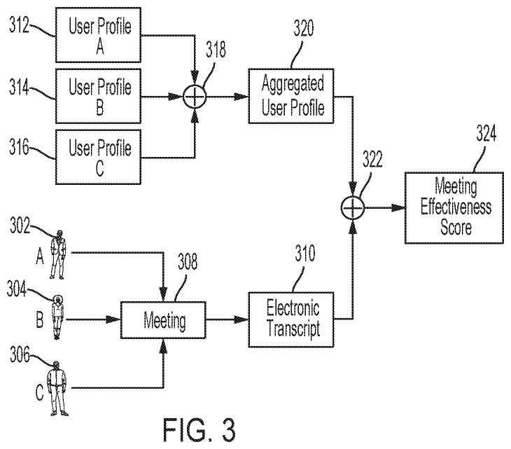

FIG. 3 illustrates an example of generating meeting effectiveness scores for meetings based on individual profiles. In this example, the system uses quantitative measurements of how effective a meeting was for a particular individual, combines measurements of multiple individuals together, and uses that information to evaluate the overall effectiveness of a meeting. That overall effectiveness can then be used, in combination with other determinations of redundancy, to modify and/or change future scheduling of meetings.

In this example, there are three users: A 302, B 304, C 306 who participate in a meeting 308. As previously discussed, the system uses speech to text processing on the audio recording of the meeting 308, resulting in an electronic transcript 310 which can be further processed using natural language processing and/or statistical analysis. Each user 302, 304, 306 has predefined user profiles 312, 314, 316, which each contain information about how the respective user prefers to communicate, be communicated with, and what results in an effective meeting for that user. The user profiles 312, 314, 316 are generated based on previous communications of the respective user (e.g., previous audio recordings, email messages, text messages (SMS messages), and can also be based on inputs provided by the user regarding their preferences. In this example, the user profiles 312, 314, 316 are aggregated together 318, resulting in an aggregated user profile 320 specifically for participants in the meeting 308. The aggregated user profile 320 represents how the participants 302, 304, 306, as a whole, judge the effectiveness of a meeting based on previous responses, communication, and interactions. Using 322 the aggregated user profile 320 and the electronic transcript 310 (before and/or after being subjected to natural language processing/statistical analysis), the system can generate a meeting effectiveness score 324, which provides a quantifiable score describing the effectiveness of the meeting 308.

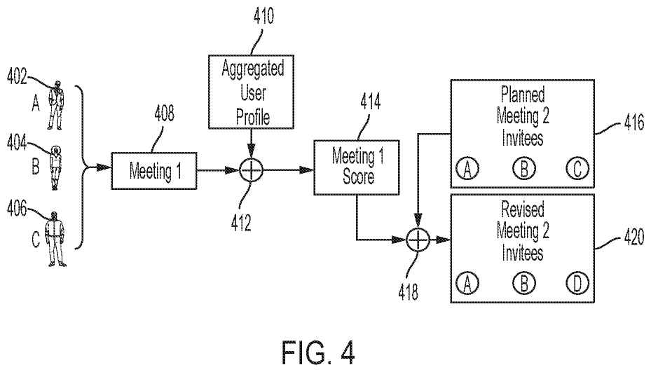

FIG. 4 illustrates an example of issuing revised electronic invitations based on a meeting effectiveness score 414. In this example, users A 402, B 404, and C 406 attend a meeting 408, and by comparing 412 a transcript of the meeting 408 with an aggregated user profile 410 (as described with FIG. 3), a meeting score 414 is generated. A second meeting (Meeting 2) had been previously scheduled, with the same invitees 416 A, B, and C, as in Meeting 1 408. The system compares 418 the meeting score 414 to the planned invitees 416, a process that can also involve identifying any redundancies based on previous discussions, planned agendas for Meeting 2, participants, etc. (as described above). Based on this decision, the system determines that user C 406 should no longer be invited to meeting 2, and revises the meeting 2 invitees 420 to include user D. The system can also update topics, agendas, speaking order, planned time periods for the topics/speakers, etc.

The effectiveness of a meeting may include several components. For example, a lack of redundancy may improve effectiveness. Effectiveness may also include better communication of knowledge/information across parties, but also doing so in a more enjoyable way, such to increase employee morale and decrease attrition. For example, two methods could be equal in information imparting, but one could leave individuals feeling empowered afterward. Accordingly, meetings may be modified to increase employee morale, “effectiveness” of meetings, lack of redundancy, and the like.

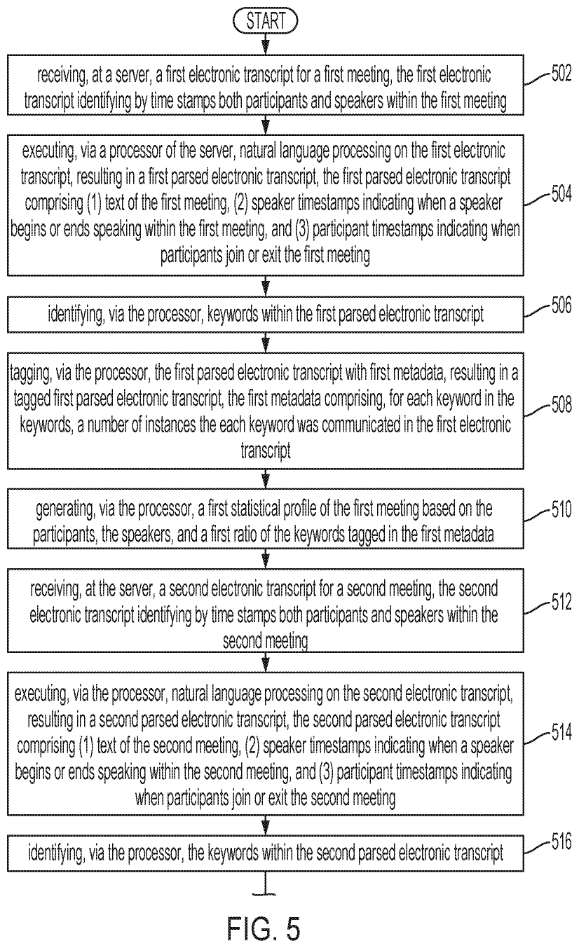

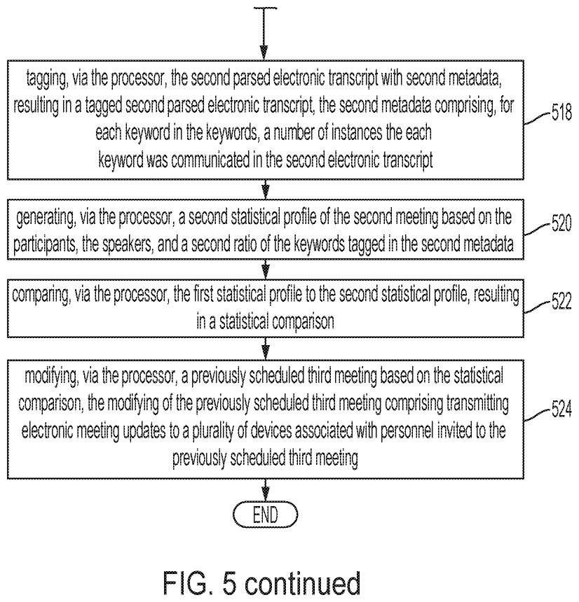

FIG. 5 illustrates an example method embodiment. The steps outlined herein are exemplary and can be implemented in any combination thereof, including combinations that exclude, add, or modify certain steps. While the methods and systems can be practiced in a variety of ways, the example method illustrated in FIG. 5 is performed by a system such as a server. The system receives a first electronic transcript for a first meeting, the first electronic transcript identifying by time stamps both participants and speakers within the first meeting (502). The system executes, via a processor of the system, natural language processing on the first electronic transcript, resulting in a first parsed electronic transcript, the first parsed electronic transcript comprising (1) text of the first meeting, (2) speaker timestamps indicating when a speaker begins or ends speaking within the first meeting, and (3) participant timestamps indicating when participants join or exit the first meeting (504). The system identifies, via the processor, keywords within the first parsed electronic transcript (506) and tags, via the processor, the first parsed electronic transcript with first metadata, resulting in a tagged first parsed electronic transcript, the first metadata comprising, for each keyword in the keywords, a number of instances each keyword was communicated in the first electronic transcript (508). The system generates, via the processor, a first statistical profile of the first meeting based on the participants, the speakers, and a first ratio of the keywords tagged in the first metadata (510).

The system then repeats this process for a second meeting. Specifically, the system receives a second electronic transcript for a second meeting, the second electronic transcript identifying by time stamps both participants and speakers within the second meeting (512); executes, via the processor, natural language processing on the second electronic transcript, resulting in a second parsed electronic transcript, the second parsed electronic transcript comprising (1) text of the second meeting, (2) speaker timestamps indicating when a speaker begins or ends speaking within the second meeting, and (3) participant timestamps indicating when participants join or exit the second meeting (514); identifies, via the processor, the keywords within the second parsed electronic transcript (516); tags, via the processor, the second parsed electronic transcript with second metadata, resulting in a tagged second parsed electronic transcript, the second metadata comprising, for each keyword in the keywords, a number of instances the each keyword was communicated in the second electronic transcript (518); and generates, via the processor, a second statistical profile of the second meeting based on the participants, the speakers, and a second ratio of the keywords tagged in the second metadata (520).

The system compares, via the processor, the first statistical profile to the second statistical profile, resulting in a statistical comparison (522), and modifies via the processor, a previously scheduled third meeting based on the statistical comparison, the modifying of the previously scheduled third meeting comprising transmitting electronic meeting updates to a plurality of devices associated with personnel invited to the previously scheduled third meeting. (524).

Modifying of the previously scheduled third meeting can include rescinding an electronic invitation for a first participant of the first meeting to the previously scheduled third meeting because the second metadata identifies a second participant of the second meeting filling a common role of the first participant. In some configurations, modifying the previously scheduled third meeting can further include: cancelling a fourth meeting, the fourth meeting having the participants and speakers of the first meeting and inviting the participants and speakers of both the first meeting and the second meeting to the previously scheduled third meeting.

The comparing the first statistical profile to the second statistical profile can include comparing the first ratio of the keywords tagged in the first metadata to the second ratio of the keywords tagged in the second metadata, resulting in a comparison and identifying, based on the comparison, that the first ratio and the second ratio are identical.

In some cases, the illustrated method can further include: identifying, via the processor, based on the first statistical profile, a first expert from the first meeting; and identifying, via the processor, based on the second statistical profile, a second expert from the second meeting, where the modifying of the previously scheduled third meeting further includes: extending invitations for the previously scheduled third meeting to both the first expert and the second expert. In such configurations, the first expert and the second expert are identified based upon the speaker timestamps and the participant timestamps stored within the first statistical profile and the second statistical profile.

Similarly, the method can further include: retrieving, at the server from a database, predefined first user profiles for each participant in the first meeting; aggregating, via the processor, the predefined first user profiles, resulting in a first aggregated user profile; generating a first meeting effectiveness score for the first meeting based on a comparison of the first statistical profile to the first aggregated user profile; retrieving, at the server from a database, predefined second user profiles for each participant in the second meeting; aggregating, via the processor, the predefined second user profiles, resulting in a second aggregated user profile; and generating a second meeting effectiveness score for the second meeting based on a comparison of the second statistical profile to the second aggregated user profile, wherein the modifying of the previously scheduled third meeting is further based on the first meeting effectiveness score and the second meeting effectiveness score.

In another example, the illustrated method can further include: storing, in a database, the first statistical profile and the second statistical profile; receiving, from device operated by a supervisor associated with the previously scheduled third meeting, via an input device, a search request for a topic within the keywords; retrieving, via the processor from the database, in response to the search request, previous meetings where the topic was discussed; transmitting, to the device, a list of previous meetings where the topic was discussed, the list of previous meetings comprising the first statistical profile and the second statistical profile; receiving, from the supervisor via the device, a preferred meeting from the list of previous meetings, wherein the modifying of the previously scheduled third meeting is further based on the preferred meeting.

In some configurations, modifying of the previously scheduled third meeting can include modifying a duration of the previously scheduled third meeting based on the speaker timestamps of the first statistical profile and the second statistical profile, and/or modifying a topic to be discussed at the previously scheduled third meeting based on the first statistical profile and the second statistical profile.

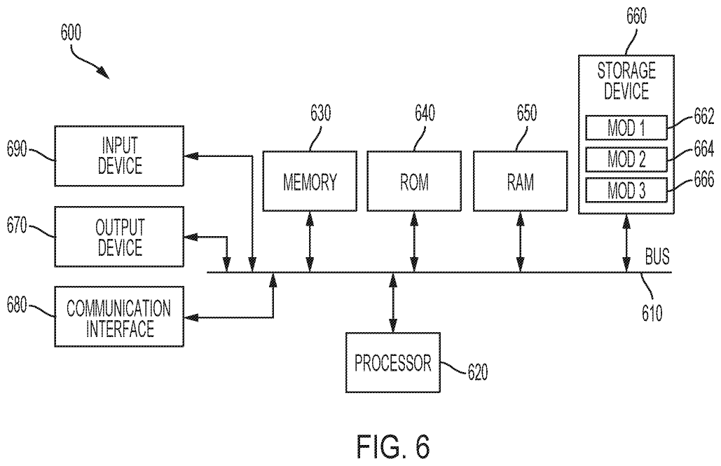

With reference to FIG. 6, an exemplary system includes a general-purpose computing device 600, including a processing unit (CPU or processor) 620 and a system bus 610 that couples various system components including the system memory 630 such as read-only memory (ROM) 640 and random access memory (RAM) 650 to the processor 620. The system 600 can include a cache of high-speed memory connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, bus 610, display 670, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at a server, a first electronic transcript for a first meeting, the first electronic transcript identifying by time stamps both participants and speakers within the first meeting;
executing, via a processor of the server, natural language processing on the first electronic transcript, resulting in a first parsed electronic transcript, the first parsed electronic transcript comprising (1) text of the first meeting, (2) speaker timestamps indicating when a speaker begins or ends speaking within the first meeting, and (3) participant timestamps indicating when participants join or exit the first meeting;
identifying, via the processor, keywords within the first parsed electronic transcript;
tagging, via the processor, the first parsed electronic transcript with first metadata, resulting in a tagged first parsed electronic transcript, the first metadata comprising, for each keyword in the keywords, a number of instances the each keyword was communicated in the first electronic transcript;
generating, via the processor, a first statistical profile of the first meeting based on the participants, the speakers, and a first ratio of the keywords tagged in the first metadata;
receiving, at the server, a second electronic transcript for a second meeting, the second electronic transcript identifying by time stamps both participants and speakers within the second meeting;
executing, via the processor, natural language processing on the second electronic transcript, resulting in a second parsed electronic transcript, the second parsed electronic transcript comprising (1) text of the second meeting, (2) speaker timestamps indicating when a speaker begins or ends speaking within the second meeting, and (3) participant timestamps indicating when participants join or exit the second meeting;
identifying, via the processor, the keywords within the second parsed electronic transcript;
tagging, via the processor, the second parsed electronic transcript with second metadata, resulting in a tagged second parsed electronic transcript, the second metadata comprising, for each keyword in the keywords, a number of instances the each keyword was communicated in the second electronic transcript;
generating, via the processor, a second statistical profile of the second meeting based on the participants, the speakers, and a second ratio of the keywords tagged in the second metadata;
comparing, via the processor, the first statistical profile to the second statistical profile, resulting in a statistical comparison; and
modifying, via the processor, a previously scheduled third meeting based on the statistical comparison, the modifying of the previously scheduled third meeting comprising transmitting electronic meeting updates to a plurality of devices associated with personnel invited to the previously scheduled third meeting.

2. The method of claim 1, wherein the modifying of the previously scheduled third meeting further comprises:
rescinding an electronic invitation for a first participant of the first meeting to the previously scheduled third meeting because the second metadata identifies a second participant of the second meeting filling a common role of the first participant.

3. The method of claim 1, wherein the modifying of the previously scheduled third meeting further comprises:
cancelling a fourth meeting, the fourth meeting having the participants and speakers of the first meeting; and
inviting the participants and speakers of both the first meeting and the second meeting to the previously scheduled third meeting.

4. The method of claim 1, wherein the comparing of the first statistical profile to the second statistical profile further comprises:
comparing the first ratio of the keywords tagged in the first metadata to the second ratio of the keywords tagged in the second metadata, resulting in a comparison; and
identifying, based on the comparison, that the first ratio and the second ratio are identical.

5. The method of claim 1, further comprising:
identifying, via the processor, based on the first statistical profile, a first expert from the first meeting; and
identifying, via the processor, based on the second statistical profile, a second expert from the second meeting,
wherein the modifying of the previously scheduled third meeting further comprises:
extending invitations for the previously scheduled third meeting to both the first expert and the second expert.

6. The method of claim 5, wherein the first expert and the second expert are identified based upon the speaker timestamps and the participant timestamps stored within the first statistical profile and the second statistical profile.

7. The method of claim 1, further comprising:
retrieving, at the server from a database, predefined first user profiles for each participant in the first meeting;
aggregating, via the processor, the predefined first user profiles, resulting in a first aggregated user profile;
generating a first meeting effectiveness score for the first meeting based on a comparison of the first statistical profile to the first aggregated user profile;
retrieving, at the server from a database, predefined second user profiles for each participant in the second meeting;
aggregating, via the processor, the predefined second user profiles, resulting in a second aggregated user profile; and
generating a second meeting effectiveness score for the second meeting based on a comparison of the second statistical profile to the second aggregated user profile, wherein the modifying of the previously scheduled third meeting is further based on the first meeting effectiveness score and the second meeting effectiveness score.

8. The method of claim 1, further comprising:
storing, in a database, the first statistical profile and the second statistical profile;
receiving, from device operated by a supervisor associated with the previously scheduled third meeting, via an input device, a search request for a topic within the keywords;
retrieving, via the processor from the database, in response to the search request, previous meetings where the topic was discussed;
transmitting, to the device, a list of previous meetings where the topic was discussed, the list of previous meetings comprising the first statistical profile and the second statistical profile;
receiving, from the supervisor via the device, a preferred meeting from the list of previous meetings,
wherein the modifying of the previously scheduled third meeting is further based on the preferred meeting.

9. The method of claim 1, wherein the modifying of the previously scheduled third meeting further comprises:
modifying a duration of the previously scheduled third meeting based on the speaker timestamps of the first statistical profile and the second statistical profile.

10. The method of claim 1, wherein the modifying of the previously scheduled third meeting further comprises:
modifying a topic to be discussed at the previously scheduled third meeting based on the first statistical profile and the second statistical profile.

11. A system for automatically reducing meeting redundancy, comprising:
a database storing a plurality of communication profiles, each communication profile associated with a respective user, each communication profile in the plurality of communication profiles comprising a data structure storing data comprising (1) a syntactic pattern followed by the respective user, (2) a statistical profile of user engagement of the respective user, and (3) a list of topics ranked according to interaction of the respective user;
a processor; and
a non-transitory computer-readable storage medium having instructions stored which, when executed by the processor, cause the processor to perform operations comprising:
receiving an electronic transcript for a meeting, the meeting having a plurality of participants;
retrieving, from the database, a communication profile for each participant in the plurality of participants, resulting in a plurality of meeting communication profiles;
aggregating the plurality of meeting communication profiles into an aggregated participant profile for the meeting, the aggregated participant profile comprising (1) a weighted syntactic pattern of the plurality of participants, (2) a weighted statistical profile, and (3) an aggregated ranked list of topics;
performing natural language processing on the electronic transcript, resulting in a parsed electronic transcript;
generating a meeting effectiveness score for the meeting by comparing the parsed electronic transcript to the aggregated participant profile; and
modifying a scheduled meeting based on the meeting effectiveness score, the modifying of the scheduled third meeting comprising transmitting at least one electronic meeting update to devices associated with personnel invited to the scheduled third meeting.

12. The system of claim 11, wherein the modifying of the scheduled meeting further comprises:
rescinding an electronic invitation for a first participant of the scheduled meeting because a second participant of the scheduled meeting fills a common role of the first participant.

13. The system of claim 11, wherein the modifying of the scheduled meeting further comprises:
cancelling a third meeting, the third meeting having the participants and speakers of the meeting; and
inviting participants of both the meeting and the third meeting to the scheduled meeting.

14. The system of claim 11, wherein the parsed electronic transcript comprises (1) a digital transcript of the meeting, (2) speaker timestamps indicating when a speaker begins or ends speaking within the meeting, and (3) participant timestamps indicating when participants join or exit the meeting.

15. The system of claim 11, the non-transitory computer-readable storage medium having additional instructions stored which, when executed by the processor, cause the processor to perform operations comprising:
receiving an audio recording of the meeting;
converting, via speech-to-text processing, the audio recording into the electronic transcript;
storing the electronic transcript within the database; and
discarding the audio recording.

16. The system of claim 15, wherein the speech-to-text processing identifies distinct speakers within the meeting, and wherein the distinct speakers are identified on the parsed electronic transcript.

17. The system of claim 11, the non-transitory computer-readable storage medium having additional instructions stored which, when executed by the processor, cause the processor to perform operations comprising:
scoring, using the plurality of meeting communication profiles and the parsed electronic transcript, an individual meeting effectiveness for each participant in the plurality of participants, resulting in individual participant meeting effectiveness scores;
identifying, based on the individual participant meeting effectiveness scores, at least one participant of the meeting for whom the meeting was not effective,
wherein the modifying of the scheduled meeting further comprises rescinding an electronic invitation for the at least one participant of the meeting for whom the meeting was not effective.

18. The system of claim 17, wherein the scoring of the individual meeting effectiveness for each participant further comprises:
identifying, from the parsed electronic transcript, a plurality of topics discussed during the meeting;
for each topic in the plurality of topics, identifying a number of time the topic was discussed in the meeting, resulting in topic discussion counts;
comparing the topic discussion counts with preferred topics of each participant as listed in the meeting communication profile for each participant; and
generating a score based on a level of similarity between the preferred topics and the topic discussion counts.

19. The system of claim 11, the non-transitory computer-readable storage medium having additional instructions stored which, when executed by the processor, cause the processor to perform operations comprising:
generating statistics using the parsed electronic transcript, the statistics identifying a plurality of topics discussed during the meeting and a number of times each topic in the plurality of topics was discussed during the meeting;
comparing the statistics to an agenda for the scheduled meeting, resulting in a comparison; and
identifying, based on the comparison, a redundant topic,
wherein the modifying of the scheduled meeting is further based on the redundant topic.

20. A non-transitory computer-readable storage medium having instructions stored which, when executed by a computing device, cause the computing device to perform operations comprising:
retrieving, from a database, a first electronic transcript for a first meeting and a second electronic transcript for a second meeting;
performing natural language processing on the first electronic transcript and the second electronic transcript, resulting in a first parsed electronic transcript and a second parsed electronic transcript;
identifying, using the first parsed electronic transcript, first topics discussed in the first meeting;
retrieving, from the database, first individual communication profiles of participants in the first meeting;
aggregating the first individual communication profiles, resulting in a first aggregated profile;
scoring an effectiveness of the first meeting using the first aggregated profile, resulting in a first meeting effectiveness score;
identifying, using the second parsed electronic transcript, second topics discussed in the second meeting;
retrieving, from the database, second individual communication profiles of participants in the second meeting;
aggregating the second individual communication profiles, resulting in a second aggregated profile;
scoring an effectiveness of the second meeting using the second aggregated profile, resulting in a second meeting effectiveness score;
identifying common keywords within the first parsed electronic transcript and the second parsed electronic transcript;
identifying a scheduled meeting, the scheduled meeting having previously assigned participants and topics;
determining a redundancy exists between the scheduled meeting and at least one of the first meeting and the second meeting using the common keywords, the first meeting effectiveness score, and the second meeting effectiveness score; and
modifying, by transmitting electronic meeting updates to a plurality of devices associated with personnel invited to the scheduled meeting, at least one of the participants and the topics of the scheduled meeting to remove the redundancy.
